(19) United States
(12) Patent Application Publication
(10) Pub. No.: US 2008/0000980 A1
(43) Pub. Date: Jan. 3, 2008

(54) Audible scan indicator

(76) Inventors: Benjamin Hejl, Cherry Hill, NJ (US); John F. Bonanno, West Deptford, NJ (US); John T. Deal, Sewel, NJ (US); Nancy A. Smith, Philadelphia, PA (US)

Correspondence Address: NANCY A SMITH;METROLOGIC INSTRUMENTS, INC, 90 COLES ROAD, BLACKWOOD, NJ, 08012, US

(21) Appl. No.: 11/478,321

(22) Filed: Jun. 29, 2006

(51) Int. Cl. G06K 7/10

(52) U.S. Cl. 235/462.01

(57) ABSTRACT

A scan mode indication method, computer-readable medium, apparatus, processor, and system are provided. In one embodiment, the method scans code using a scan mode and transmits a mode output signal indicative of the scan mode. In various embodiments, the mode output signal is an audio output signal. The audio output signal can be at least one audio tone or at least one word. In yet other embodiments, a computer-readable medium, an apparatus, a processor, and a system are also provided which perform similar features recited by the above method.

### BACKGROUND OF THE INVENTION

1. Field of the Invention

One or more aspects of the present invention generally relate to optical scanning systems and more particularly, to audio indication/confirmation of a scan mode, after scanning optical code, in a light based symbol scanner.

2. Description of the Related Art

Optical scanners have been used to read and interpret various types of optical code symbols. Examples of such code include, but are not limited to, Universal Product Code (“U.P.C.”), European Article Numbering (“E.A.N.”), Japanese Article Numbering (“J.A.N.”), International Article Numbering (“I.A.N.”), and PDF417. In addition, the codes are not uniform. For example, U.P.C. can be 8, 12, 13, or 14 digits in length.

Optical code is typically located on item labeling. Because of the ease in which optical code can be placed on items, optical code can be used in many environments. For example, point-of-sale (“P.O.S.”) stations in retail stores and supermarkets, in inventory management (e.g., document tracking), and in diverse data control applications.

Most scanning systems, or scanners, generate a beam of light which reflects off optical code symbols so that the scanning system can receive the reflected light. The system then transforms that reflected light into electrical signals, and decodes those electrical signals to extract the information embedded in the optical code symbols. Scanners can include (and scan using) a group of substantially parallel scan lines or multiple groups of substantially parallel scan lines.

Code can be read by moving the code closer to the scanner but that would depend on the length and size of the code and the space between the desired bar code and other bar code. Although code has a finite length, as explained above there is non-uniformity in the number of digits that a code uses. This non-uniformity and proximity to other code can sometimes make it difficult to place the scanner at an appropriate distance from the code to read the entire length of code and not scan other code.

Because of exemplary factors such as code non-uniformity, proximity of one set of code with respect to another set(s) of code, and orientation of code with respect to the symbol reader code can be misread. To gain greater control over scanning, users often want feedback (e.g., confirmation) regarding the mode in which the code was scanned.

Therefore, there is a great need in the art for an improved laser scanning mechanism which avoids the shortcomings and drawbacks of prior art laser beam scanning apparatus and methodologies.

### SUMMARY

These and other deficiencies of the prior art are addressed by the present invention which generally relates to laser scanning systems and more particularly, to audio indication/confirmation of a scan mode, after scanning optical code, in a light based symbol scanner. In one embodiment, a method is provided which receives a switch scan mode signal and transmits an output signal in accordance with the switch scan mode signal. In various embodiments of the method, the mode output signal is an audio output signal. The audio output signal can be at least one audio tone or at least one word.

Other embodiments are also provided in which a computer-readable medium, an apparatus, a processor, and a system perform similar features recited by the above methods.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only aspects of this disclosure and are therefore not to be considered limiting of its scope, for the invention may admit to other equally effective embodiments.

FIG. 1 is a perspective view of an illustrative scanning system used in accordance with aspects of this disclosure;

FIG. 2 is a perspective view of an exemplary symbol reading system used in accordance with aspects of this disclosure;

FIG. 3 is a close up view an exemplary scan mode depicted in FIG. 2;

FIG. 4 depicts an exemplary high level block diagram of a system in accordance with aspects of this disclosure;

FIG. 5 depicts a flow diagram of an illustrative method used in accordance with aspects of this disclosure; and

FIG. 6 depicts a high level block diagram of a computer architecture for performing aspects of this disclosure.

To facilitate understanding, identical reference numerals have been used, wherever possible, to designate identical elements that are common to the figures.

### DETAILED DESCRIPTION

In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of this invention.

For illustrative purposes only, the invention is described as capable of scanning bar code symbols. However that depiction is not intended in any way to limit the scope of the invention. It is appreciated that the invention can be used with scanners that scan other types of symbols.

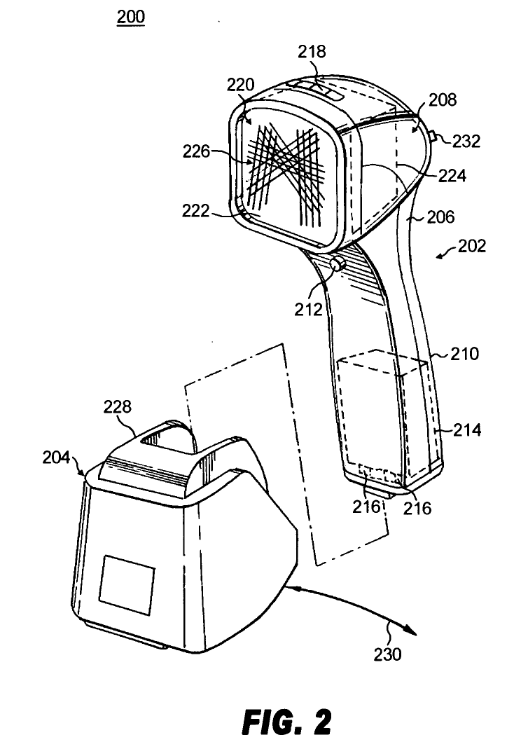

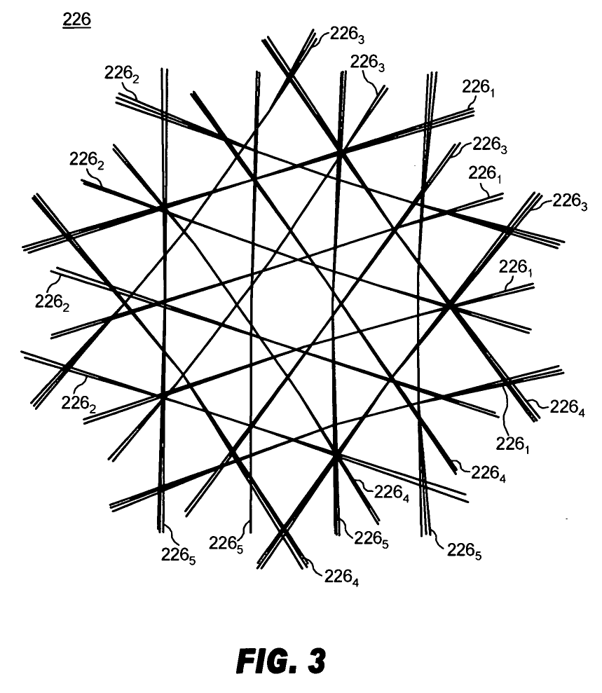

“Mode,” as used herein, describes a scan pattern. The scan pattern can be a selection of a group of substantially parallel scan lines (e.g., a raster scan pattern); or a selection of more than one group of substantially parallel scan lines. “Mode” can be any set (singular or multiple; and either substantially horizontal or on an angle) of scan lines. Illustratively, there can be a single set of substantially horizontal scan lines; a set which includes at least one group of angled scan lines (e.g., four groups of scan lines at forty-five degree angles); or a set which includes a combination of at least one group of substantially horizontal scan lines and at least one group of angled scan lines. For example, a scanner is in one mode if scanning is omni-directional (i.e., multiple groups of substantially parallel scan lines for scanning symbols oriented in various positions with respect to the scanner (examples of multiple groups of substantially parallel scan lines are shown in FIGS. 2 and 3)); in another mode if a single group of substantially parallel scan lines are selected; and yet in another mode, if at least two groups (but not as many groups as in the omni-directional mode) of substantially parallel scan lines are selected.

“Menu scanning” is when there is a sheet of closely spaced sets of bar code (i.e., a menu) and there is only a desire to scan select bar code.

It is appreciated that the invention is not limited to the types of scanners disclosed herein. This document incorporates by reference all of the material disclosed within commonly owned and assigned U.S. Pat. No. 6,227,450 issued May 8, 2001 and entitled ELECTRONICALLY-CONTROLLED MECHANICALLY-DAMPED OFF-RESONANT LIGHT BEAM SCANNING MECHANISM AND CODE SYMBOL READERS EMPLOYING THE SAME; commonly owned and assigned U.S. Pat. No. 5,796,091 issued Aug. 18, 1998 and entitled AUTOMATIC HAND-SUPPORTABLE OMNIDIRECTIONAL LASER PROJECTION SCANNER WITH HANDLE-CONTROLLABLE PROJECTION AXIS; commonly owned and assigned U.S. Pat. No. 5,808,285 issued Sep. 15, 1998 and entitled PORTABLE CODE SYMBOL READING DEVICE WITH ONE-WAY WIRELESS DATA PACKET TRANSMISSION LINK TO BASE UNIT EMPLOYING CONDITION-DEPENDENT ACOUSTICAL SIGNALLING FOR DATA PACKET RECEPTION ACKNOWLEDGEMENT; commonly owned and assigned U.S. patent application Ser. No. 11/203,669 published Feb. 23, 2006 and entitled POINT OF SALE (POS) BASED BAR CODE READING AND CASH REGISTER SYSTEMS WITH INTEGRATED INTERNET-ENABLED CUSTOMER-KIOSK TERMINALS; U.S. Pat. No. 4,460,120 issued Jul. 17, 1984 and entitled NARROW BODIED, SINGLE-AND TWIN-WINDOWED PORTABLE LASER SCANNING HEAD FOR READING BAR CODE SYMBOLS; and U.S. Pat. No. 5,321,246 issued Jun. 14, 1994 and entitled BAR CODE SCANNER WITH RF COUPLING TO BASE TERMINAL AND AUTOMATIC TURN-OFF UPON DECODE, as if being set forth in its entirety herein.

Symbol (e.g., bar code) scanners are often used in point-of-sale (“P.O.S.”) symbol scanning systems. Generally, P.O.S. scanning systems include a symbol scanner and a customer payment apparatus; or the symbol scanner, the customer payment apparatus, and a cashier terminal. The invention is described herein using a P.O.S. symbol scanning system. However, it is appreciated that aspects of the present invention can be incorporated into either of these two types (as well as other) P.O.S. scanning systems; or scanning systems used for other applications.

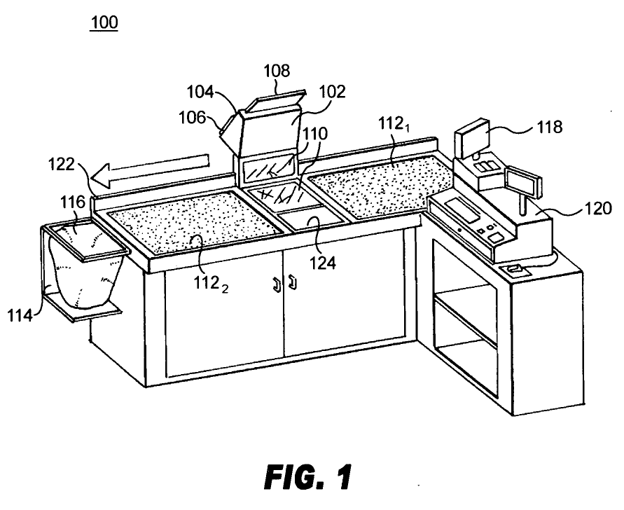

FIG. 1 is a perspective view of an illustrative P.O.S. scanning system 100 used in accordance with the invention. P.O.S. scanning system 100 includes a check-out stand 122 which supports an optical scanner 110, a customer payment apparatus 102, and a cashier terminal 120. Illustratively, the optical scanner 110 is depicted as a bi-optical-type (i.e., two scanners depicted as scanners 110₁ and 110₂ and collectively described herein as optical scanner 110) laser-scanning bar code symbol reading system.

Check out stand 122 includes an integrated electronic produce scale subsystem 124 juxtaposed to the optical scanner 110. Illustratively, the check-out stand 122 includes conveyors 112₁ and 112₂ on either side of the customer payment apparatus 102. An item may travel along conveyor 112₁ towards the optical scanner 110; and along conveyor 112₂ thereafter. As the item passes across the optical scanner 110, optical code located on the item is scanned (in accordance with the current scan mode of the optical scanner 110).

After the item is scanned, information (e.g., the name of the item and removal of the item from inventory) associated with the scanned symbols is displayed on display 118. In addition, indication (e.g., an audible signal) regarding the scan mode is also transmitted after scanning of the item. The audible indication can be in the form of an audible tone or series of audible tones; or an audible word or series of audible words. The audible indication can be provided at the check-out stand 122 or remotely.

After scanning, payment for the item may be made via the customer payment apparatus 102. The customer payment apparatus 102 accepts payment by cash and/or credit/debit card (via a magnetic strip reader 106). Optionally, the customer payment apparatus 102 includes an Automated Teller Machine (“ATM”) 104 and an ATM display 108.

In one embodiment, an end user (e.g., a cashier) at the cashier station 120 scans items on the scanner 110. After scanning each item, an audible signal is generated that indicates what scan mode the item was scanned in (e.g., one audible tone when scanned in omni-directional mode). A different audible feedback can be provided for each scan mode. In another example, there are two horizontal sets of bars (where only one is intended to be read), if the scanner is in a 45 degree mode, the scanner could potentially (and mistakenly) read a portion of each of the bar code lines. When performing menu scanning in the omni-directional mode a tone is generated indicating that a scanning attempt in omni-directional mode. The audible signal may serve to indicate that you did not scanning in the desired mode. Sometimes it is difficult to tell which code was actually scanned as opposed to the code that was desired to be scanned because the scan lines could have lines crossing multiple sets of bar code. Knowing which scan mode was actually used serves as a confirmation so that changing the scan mode or the orientation of the scanner with respect to the code can be made if desired.

For example, even when code is scanned (i.e., read and erroneously interpreted) knowledge of the actual scan mode may lead to a determination that the scan mode needs to be changed. In addition, a failure to scan may be the result of scanning in an improper scan mode.

FIG. 2 is a perspective view of another exemplary symbol reading system 200 used in accordance with the invention. The symbol reading system 200 includes a symbol reading device 202 and an optional base unit 204.

The symbol reading device 202 is within a housing 206. The housing 206 includes a head portion 208 and a handle portion 210. Inside of the housing 206 are a number of components. These components can be located either within (or on) the head portion 208 or within (or on) the handle portion 210. It is appreciated that although FIG. 2 depicts components as having a specific location within the housing 206 that depiction is for illustrative purposes only.

Some components included inside the housing 206 are a power supply 214 (e.g., a rechargeable battery); a scan engine 224; and circuitry (not shown) for performing various function such as, but not limited to, transmission of a carrier signal (e.g., an RF carrier signal and providing an audible signal). The scan engine 224 includes components for detecting and reading symbols. Visible from the exterior of the head portion 208 are optional indicator lights 218 and an activation switch 212 for manual user activation (i.e., for scanning code) of the symbol reading device 202. The indicator lights 218 can be a set of color-coded state indicator lights, for visually displaying a particular state in which the system 200 resides at any instant of time. Head portion 208 also includes a light transmission aperture 222. Covering the light transmission aperture 222 is a light transmission window 220.

Electrical power is supplied from power supply 214 to the circuitry and the symbol reading engine 224. When the scanner 202 is placed within the base unit 204, the power supply 214 is charged by contact points 216 and corresponding points (not shown) on the base unit 204. In addition to charging the scanner 202, the base unit 204 can (in various embodiments) provide a communications link with a host computer.

FIG. 3 is a close up view an exemplary scan mode 300 depicted in FIG. 2. Mode 300 is a selected omni-directional scan mode which is illustratively depicted as having five groups (226₁, 226₂, 226₃, 226₄, and 226₅ collectively referred to (and depicted) in FIG. 2 as scan lines 226) of substantially parallel scan lines. It is appreciated that although the omni-directional mode 300 is depicted as having five groups of substantially parallel lines 226 more or less groups of scan lines can be included.

A different mode may be selected (e.g., by an end user) which has a different number of groups of scan lines. For example, a mode can be selected where only one of the groups 226₁, 226₂, 226₃, 226₄, or 226₅ is utilized. In another example, a scan mode can be selected where at least two of the groups 226₁, 226₂, 226₃, 226₄, or 226₅ are utilized. After scanning, a different audible signal is transmitted for each of the 226₁, 226₂, 226₃, 226₄, and 226₅.

In addition, FIG. 3 depicts each group 226 as having four scan lines. However, that depiction is for illustrative purposes only. Each group 226 may contain more or less scan lines. For example, some scanners produced by Metrologic Instruments, Inc. of Blackwood, N.J. have a single scan line which utilizes a spinning polygon and mirrors to produce twenty unique scan lines. Some of the scan lines can be made more visible than other scan lines. By knowing where the polygon is, its rotation more or less current to the laser can brighten or dim scan lines accordingly. Optionally, if code is scanned in a particular orientation, only scan lines in that particular orientation can be illuminated. For example, when scanning in menu scanning mode, it is often desirable to aim the scan line at a symbol (e.g., bar code) and/or to see which scan line is scanning.

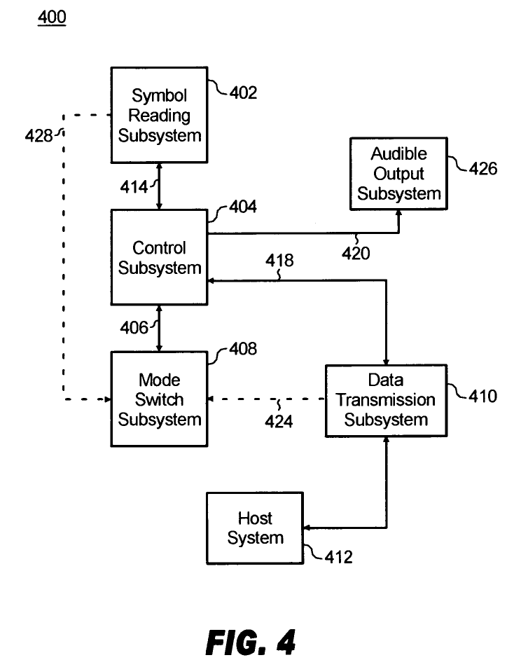

FIG. 4 depicts an exemplary high level block diagram of a system 400. The system 400 includes a symbol reading subsystem 402, a control subsystem 404, mode switch subsystem 408, a data transmission subsystem 410, a host system 412, and an audible output subsystem 420.

The symbol reading subsystem 402 attempts to scan optical code in a selected scan mode. After the attempted scan mode the symbol reading subsystem 402 sends information regarding the scan mode that the scan attempt used towards the control subsystem 404 via bidirectional communications link 414.

Some of the functions performed, by the control subsystem 404, are the transmission and reception of instructions. When the control subsystem 404 receives the information regarding a scan (e.g., a successful read and interpretation of code), the control subsystem 404 transmits a signal indicative of the actual scan mode. The control subsystem 404 also has information regarding the success or failure of the scan attempt.

In various embodiments, the indicative signal can be transmitted towards the data transmission subsystem 410 via communications link 418. Thereafter the indicative scan mode signal can be transmitted from the data transmission subsystem 410 towards the host system 412 (or other system). In addition, after transmission by the data transmission subsystem 410, the indicative scan mode signal can be converted (by the host system or other system) to an audible scan mode signal.

In other embodiments, the indicative scan mode signal is an audible signal. For example, the indicative scan mode signal can be transmitted from the control subsystem 404 towards the audible output subsystem 426 via link 420.

If a determination is made that the scan attempt was made in an improper scan mode. The scan mode can be changed. For example, the scan mode can be change by mode switch subsystem 408. An exemplary mode switch subsystem is described in co-pending commonly owned and assigned U.S. Patent Application No. ______ entitled “AUDIBLE PATTERN SWITCHING INDICATOR” filed ______ and is incorporated, in its entirety, by reference herein.

The transmission paths 416, 418, and 424 utilized by the data transmission subsystem 410 can be a wired communications path (e.g., utilizing an RS 232 connection) and/or a wireless communications path (e.g., a radio frequency transmission or infrared transmission; or utilize various communications protocols (e.g., Bluetooth or SONET)).

In various embodiments, the data transmission subsystem 410 can be configured to transmit the indicative scan mode signal from existing systems; and third party systems. For example, the present invention can be subsequently added to scanning systems and/or computer systems already being utilized; prepackaged with a scanning system distributed by another manufacturer; or prepackaged with a computer system distributed by another manufacturer.

When the switch scan mode instruction is received by the data transmission subsystem 410, the data transmission subsystem 410 transmits the switch scan mode instruction towards the control subsystem 404 via communications path 418; and/or towards the mode switch subsystem 408 via communications path 424.

When the mode switch subsystem 408 receives the switch scan mode signal from the device switch 230; the symbol reading subsystem 402; the control subsystem 404; or the host system 412, the mode switch subsystem 408 switches the scan mode of the symbol reading subsystem 402. Thereafter, the mode switch subsystem 408 sends the selected scan mode information towards the control subsystem 404 via bidirectional communication path 406. The control subsystem 404 sends the selected scan mode information towards the audible output subsystem 426 via communication path 420.

The audible output subsystem transmits an audible signal associated with the selected scan mode. The audible signal thus informs the user of the selected scan mode. The audible signal can be an audible tone or at least one word (e.g., diagonal scanning or omni-directional scanning, or menu scanning). The words used can be in a language desired by the end user. The audible output subsystem 426 includes a transducer or speaker in addition to other circuit elements for interpreting the information received from the control subsystem 404 and providing the selected scan mode audible indication.

Different scanning systems will sometimes use different circuit boards. It is appreciated that the functions performed by the subsystems (402, 404, 408, 410, 426, and 430) described herein can be incorporated onto the same circuit board or a combination of circuit boards.

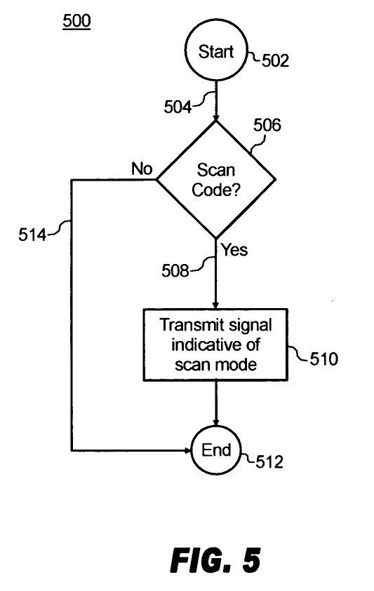

FIG. 5 is an embodiment of a flow diagram of a method 500 in accordance with aspects of this disclosure. The method 500 begins at step 502 and proceeds, via lead-line 504, to step 506.

At step 506 a determination is made whether optical code is scanned. An affirmative determination is made if optical code is successfully scanned (i.e., translated and accepted as valid optical code). The method 500 proceeds, via communication pathway 508, to step 510.

At step 510, the method 500 transmits a scan mode signal indicating what scan mode the scanner 202 scanned the optical code. In various embodiments, the scan mode signal is an audio signal. The audible signal can be pre-programmed by an end user. For example, the audio signal can be at least one word (e.g., “omni-directional mode” or “menu scanning”) or at least one tone (e.g., one beep or a series of beeps). Thereafter, the method 500 proceeds to and ends at step 512.

If, at step 506, a negative determination is made (i.e., an unsuccessful scan attempt) the method proceeds to and ends at step 512. In other embodiments, the method 500, at step 506, proceeds to step 510 when a negative determination is made at step 506.

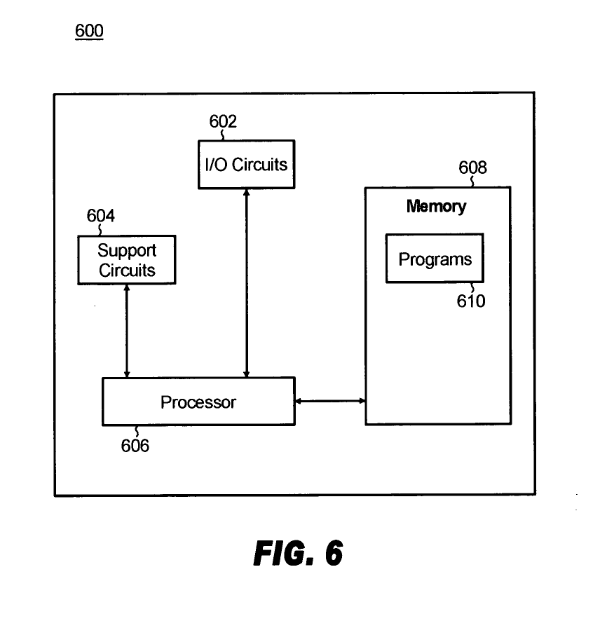

FIG. 6 depicts a high level block diagram of an embodiment of a controller 600, as part of electronic circuitry, suitable for use in providing a scan mode indicator (e.g., an audible signal) in accordance with a selected operation mode. The controller 600 of FIG. 6 comprises a processor 606 as well as a memory 608 for storing control programs and the like. The processor 606 cooperates with conventional support circuitry 604 such as power supplies, clock circuits, cache memory and the like as well as circuits that assist in executing the software routines stored in the memory 608. As such, it is contemplated that some of the process steps discussed herein as software processes may be implemented within hardware, for example, as circuitry that cooperates with the processor 606 to perform various steps. The controller 600 also contains input-output circuitry 602 that forms an interface between the various functional elements communicating with the controller 600. For example, in various embodiments, the controller 600 also communicates with a data transmission subsystem 410.

Although the controller 600 of FIG. 6 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof

It has been described herein that the audible indicator is generated after a successful scan however that description is for illustrative purposes only. It is appreciated that the audible signal can be generated after an unsuccessful scan attempt.

Although various embodiments that incorporate the teachings of the present invention have been shown and described in detail herein, those skilled in the art can readily devise many other varied embodiments that still incorporate these teachings.

We claim:

1. A method comprising:
scanning code using a scan mode; and
transmitting a mode output signal indicative of said scan mode.

2. The method of claim 1 wherein said output signal comprises an audio output signal.

3. The method of claim 2 wherein said audio signal comprises at least one tone.

4. The method of claim 2 wherein said audio signal comprises at least one word.

5. The method of claim 1 wherein said scan mode comprises a raster scan pattern.

6. The method of claim 5 wherein said raster scan pattern comprises at least one group of substantially parallel scan lines.

7. The method of claim 1 wherein said scan mode is selected from a plurality of scan modes.

8. A computer-readable medium having stored thereon a plurality of instructions, the plurality of instructions including instructions which, when executed by a processor, cause the processor to perform the steps comprising of:
scanning code using a scan mode; and
transmitting a mode output signal indicative of said scan mode.

9. The method of claim 8 wherein said mode output signal comprises an audio signal.

10. The method of claim 9 wherein said audio signal comprises at least one tone.

11. The method of claim 9 wherein said audio signal comprises at least one word.

12. The method of claim 8 wherein said scan mode comprises a raster scan pattern.

13. The method of claim 12 wherein said raster scan pattern comprises at least one group of substantially parallel scan lines.

14. The method of claim 8 wherein said scan mode is selected from a plurality of scan modes.

15. Apparatus comprising:
an output adapted to scan code using a scan mode; and
a transmitter adapted to transmit a mode output signal indicative of said scan mode.

16. The apparatus of claim 15 wherein said mode output signal comprises an audio signal.

17. The apparatus of claim 16 wherein said audio signal comprises at least one tone.

18. The apparatus of claim 16 wherein said audio signal comprises at least one word.

19. The apparatus of claim 16 further comprising at least one of a transducer and a speaker.

20. The apparatus of claim 15 wherein said scan mode comprises a raster scan pattern.

21. The apparatus of claim 20 wherein said raster scan pattern comprises at least one group of substantially parallel scan lines.

22. The apparatus of claim 15 wherein said scan mode is selected from a plurality of scan modes.

23. A processor comprising:
a first subsystem configured to scan code using a scan mode; and
a second subsystem in communication with said first subsystem and configured to transmit a mode output signal indicative of said scan mode.

24. The processor of claim 23 wherein said mode output signal is an audio output signal.

25. The processor of claim 24 wherein said audio output signal is a least one audible tone.

26. The processor of claim 24 wherein said audio output signal is at least one word.

27. A system comprising:
a symbol reading subsystem adapted to scan optical code;
a control subsystem coupled to said first subsystem and adapted to communicate a scan mode signal; and
an audible output subsystem coupled to said control subsystem and adapted to provide an audible output.

28. The system of claim 27 wherein said audible output subsystem comprises at least one of a transducer and a speaker.

29. The system of claim 27 further comprising a data transmission subsystem coupled to said control subsystem wherein said data transmission subsystem is adapted to perform at least one of a transmission of information from said system and a transmission of information to said system.
